(19) United States
(12) Patent Application Publication
(10) Pub. No.: US 2016/0186966 A1
(43) Pub. Date: Jun. 30, 2016

(54) MOVABLE BALL-SHAPE CONNECTOR FOR LIGHTING FIXTURE

(71) Applicant: Mao-Song Shen, New Taipei City (TW)

(72) Inventor: Mao-Song Shen, New Taipei City (TW)

(21) Appl. No.: 14/583,307

(22) Filed: Dec. 26, 2014

(51) Int. Cl. F21V 21/26; F21V 21/116; F16C 11/06

(52) U.S. Cl. CPC F21V 21/26; F16C 11/0623; F21V 21/116

(57) ABSTRACT

A movable ball-shape connector for a lighting fixture includes a movable rod, a spherical body, a fix cup, a press block, a spring, and an adjusting block. The spring is disposed between the spherical body and the adjusting block, to produce an elastic force acting upward. And that is used to produce the force to press the spherical body to stay between the movable rod and the fix cup, to fix the spherical body to a certain angle after rotation. Meanwhile, the adjusting block can be rotated, to make it move upward or downward, to adjust the force of the spring pressing against the spherical body, in achieving the objective of fixing the spherical body to a certain angle after rotation.

### BACKGROUND OF THE INVENTION

1. Field of the Invention

The present invention relates to a movable ball-shape connector for a lighting fixture, and in particular to a movable ball-shape connector for a lighting fixture, that can be used to fix a spherical body to a certain angle after rotation, by means of the pressing force of a spring.

2. The Prior Arts

In the prior art, the movable ball-shape connector is not provided with a pressing and fixing structure, and it is locked and fixed onto a spherical body inside through a moving rod, to press the spherical body to fix in a certain angle.

However, through this way of locking and fixing, the pressing force is rather limited, thus it is not able to exert enough pressing force to the spherical body, and to fix it to a proper angle.

Therefore, presently, the design and performance of connector for lighting fixture is not quite satisfactory, and it has much room for improvement.

### SUMMARY OF THE INVENTION

A major objective of the present invention is to provide a movable ball-shape connector for a lighting fixture, that can be used to fix a spherical body to a certain angle after rotation, by means of the pressing force of a spring.

In order to achieve the objective mentioned above, the present invention provides a movable ball-shape connector for lighting fixture, mainly comprising:

a movable rod, a spherical body, a fix cup, a press block, a spring, and an adjusting block.

In the structure mentioned above, the movable rod is provided with a lower end connected to a threaded rod extending outward, the threaded rod having a proper length, and on its surface is provided with outer threads. The spherical body is provided in its center with a through hole penetrating from its upper end to its lower end, such that the threaded rod can be put through the through hole, to install the spherical body to an upper end of the threaded rod. A fix cup is provided in its center with a through hole, such that the threaded rod can be put through the through hole, to put the fix cup on the threaded rod and below the spherical body.

The press block is provided in its center with a through hole, such that the threaded rod can penetrate through the through hole, to install the press block on the threaded rod and below the fix cup. The spring is sleeved around and on the threaded rod, and below the press block, to make an upper end of the spring pressed against the press block.

The adjusting block is provided in its center with a threaded hole, through threading the threaded hole around and onto the outer thread of the threaded rod, to install the adjusting block onto the threaded rod and below the spring, so that the lower end of the spring is pressed against the adjusting block, to make the spring to generate an elastic force acting upward, thus producing a force pressing the spherical body to stay between the movable rod and the fix cup, such that after rotation, the spherical body is fixed to a certain angle. Meanwhile, the adjusting block is rotated, so that the adjusting block is moved upward or downward along the outer threads of the threaded rod, to adjust force of the spring pressing against the spherical body.

In this way, through the upward elastic force of the spring, a force pressing the spherical body to stay between the movable rod and the fix cup can be produced, such that after rotation, the spherical body can be fixed to a certain angle. Meanwhile, the adjusting block is rotated, so that it can be moved upward or downward along the outer threads of the threaded rod, to adjust force of the spring pressing against the spherical body, hereby achieving the objective of fixing the spherical body to a certain angle after rotation.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from this detailed descriptions.

### BRIEF DESCRIPTION OF THE DRAWINGS

The related drawings in connection with the detailed descriptions of the present invention to be made later are described briefly as follows, in which:

FIG. 1 is a cross section view of a movable ball-shape connector for lighting fixture according to the present invention;

FIGS. 2 and 3 are schematic diagrams of movements of a movable ball-shape connector for a lighting fixture according to the present invention;

FIG. 4 is a schematic diagram showing a seat body used for a movable ball-shape connector for a lighting fixture according to the present invention;

FIG. 5 is a schematic diagram showing a light hood used for a movable ball-shape connector for a lighting fixture according to the present invention; and

FIGS. 6 and 7 are schematic diagrams of movements of a movable ball-shape connector for a lighting fixture according to the present invention.

### DETAILED DESCRIPTION OF THE PREFERRED EMBODIMENT

The purpose, construction, features, functions and advantages of the present invention can be appreciated and understood more thoroughly through the following detailed description with reference to the attached drawings.

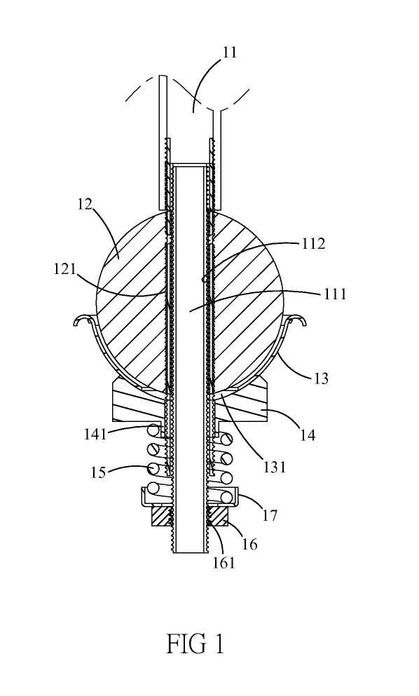

Refer to FIG. 1 for a cross section view of a movable ball-shape connector for a lighting fixture according to the present invention. As shown in FIG. 1, the movable ball-shape connector for a lighting fixture mainly includes: a movable rod 11; a spherical body 12; a fix cup 13; a press block 14; a spring 15; and an adjusting block 16.

In the descriptions above, the lower end of the movable rod 11 is provided with a threaded rod 111 extending outward. The threaded rod 111 has a proper length, and on its surface is provided with outer threads 112.

The spherical body 12 is provided in its center with a through hole 121 penetrating from its upper end to its lower end, such that the threaded rod 111 can be put through the through hole 121, to install spherical body 121 to an upper end of the threaded rod 111.

The fix cup 13 is provided in its center with a through hole 131, such that the threaded rod 111 can be put through the through hole 131, to install the fix cup 131 on the threaded rod 111 and below the spherical body 12.

The press block 14 is provided in its center with a through hole 141, such that the threaded rod 111 can be put through the through hole 141, to install the press block 14 on the threaded rod 111 and below the fix cup 13.

The spring 15 is sleeved around the threaded rod 111 and is located below the press block 14, to press an upper end of the spring 15 against the press block 14.

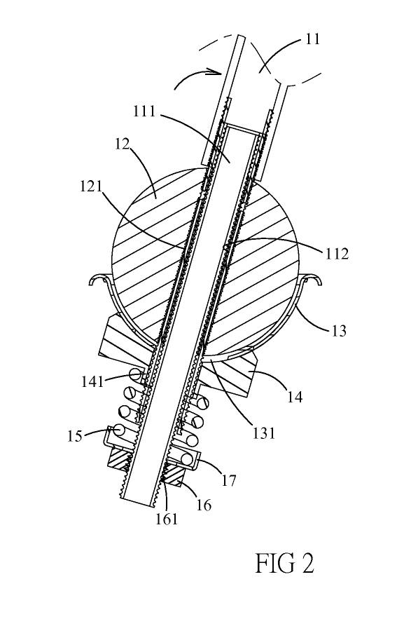

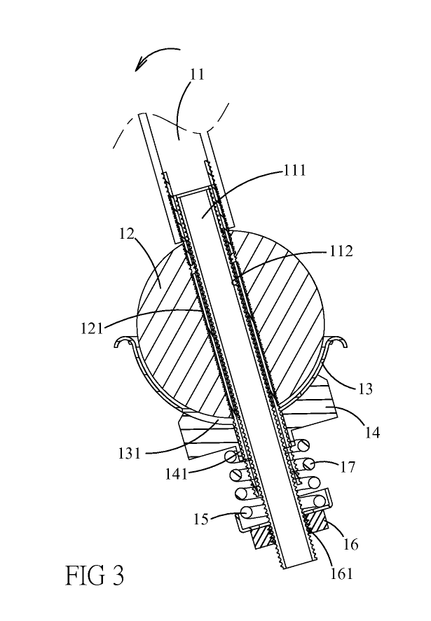

The adjusting block 16 is provided in its center with a threaded hole 161. Through threading the threaded hole 161 around and onto the outer threads 112 of the threaded rod 111, the adjusting block 16 is installed onto the threaded rod 111 and below the spring 15, so that the lower end of the spring 15 is pressed against the adjusting block 16, to make the spring 15 to produce an elastic force acting upward, thus generating a force pressing the spherical body 12 to stay between the movable rod 11 and the fix cup 13, such that after rotation, the spherical body 12 is fixed to an angle (as shown in FIGS. 2 and 3). Meanwhile, the adjusting block 16 is rotated, so that the adjusting block 16 is moved upward or downward along the outer threads 112 of the threaded rod 111, to adjust force of the spring 15 pressing the spherical body 12.

Through the structure mentioned above, and also as shown in FIGS. 2 and 3, such that in application, through the elastic force of the spring 15 acting upward, to produce a force to press the spherical body 12 to stay between the movable rod 11 and the fix cup 13, so that after rotation, the spherical body 12 is fixed to a certain angle. Meanwhile, the adjusting block 16 can be rotated, to make the it move upward or downward along the outer threads 112 of the thread rod 111, to press or release the spring 15, thus adjusting the force pressing against the spherical body 12 by the spring 15.

In this approach, it can achieve the objective and effect of fixing the spherical body 12 to a certain angle after rotation, and adjusting the force of the spring 15 pressing against the spherical body 12.

Refer again to FIG. 1, a spring receiving slot 17 is further provided between the spring 15 and the adjusting block 16, so that the lower end of the spring 15 is received in the spring receiving slot 17, to press indirectly against the adjusting block 16.

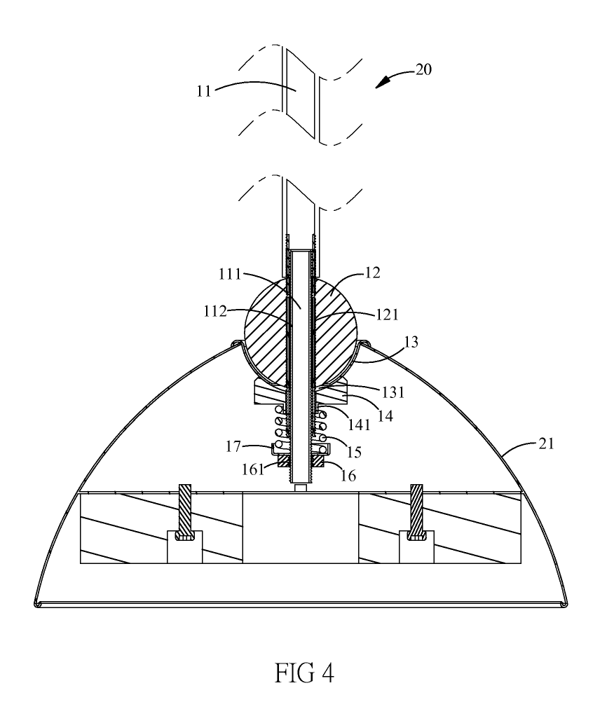

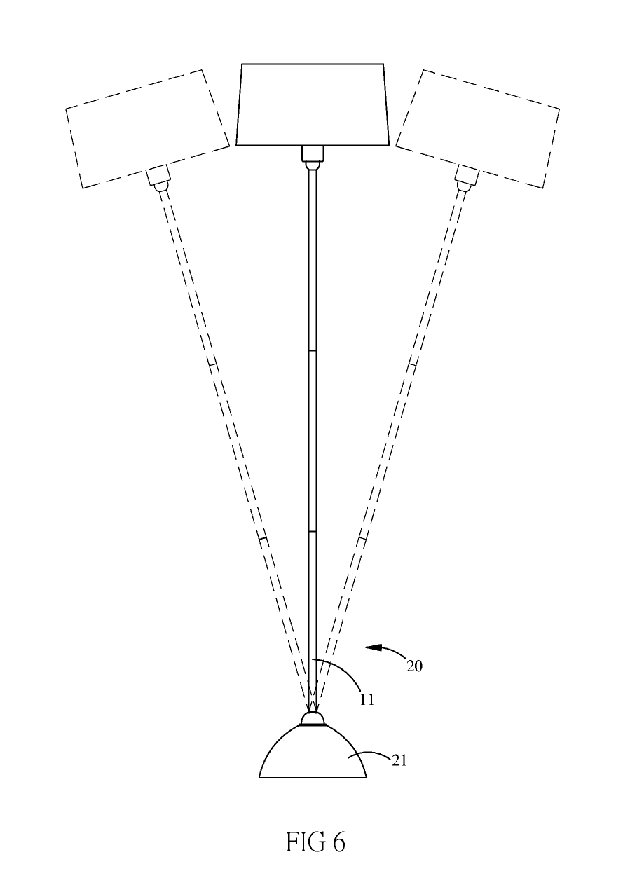

Refer to FIGS. 4 and 6 respectively for a schematic diagram showing a seat body used for a movable ball-shape connector for a lighting fixture according to the present invention, and a schematic diagram of movements of a movable ball-shape connector for a lighting fixture according to the present invention. As shown in FIGS. 4 and 6, the fix cup 13 can be installed on a seat body 21 of the light fixture 20, so that by pushing the movable rod 11, the spherical body 12 is made to rotate on the fix cup 13, to bring the movable rod 11 to swing in various angles, such that after swing, the movable rod 11 is fixed to an angle through force produced by the spring 15 pressing against the spherical body 12, as shown in FIG. 6.

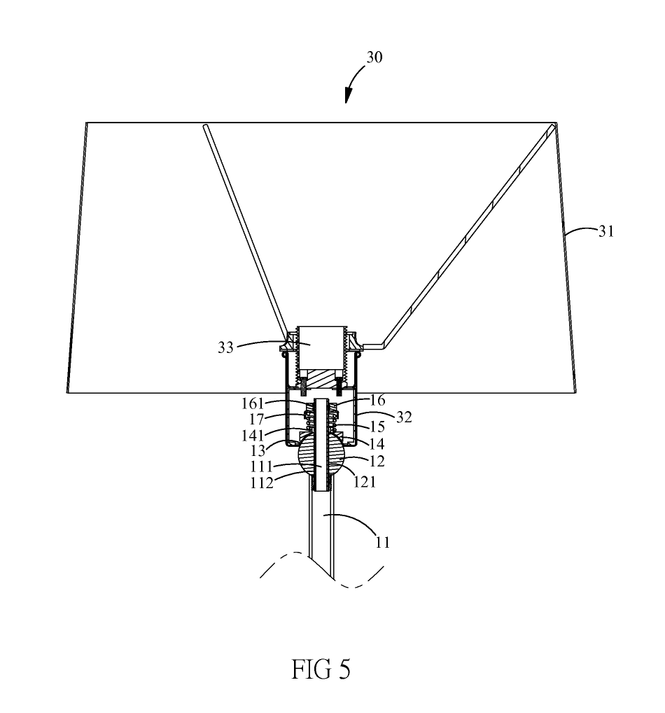

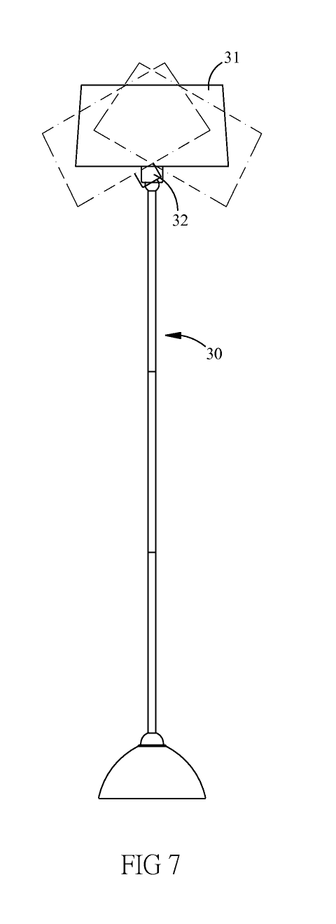

Refer to FIGS. 5 and 7 respectively for a schematic diagram showing a light hood used for a movable ball-shape connector for a lighting fixture according to the present invention and a schematic diagram of movements of a movable ball-shape connector for a lighting fixture according to the present invention. As shown in FIGS. 5 and 7, the fix cup 13 can be disposed on a connection block 32 for a light hood 31 of the light fixture 30, and above the connection block 32 is provided with a lamp seat 33 for installing a light bulb, so that by pushing the connection block 32, the spherical body 12 is made to rotate on the fix cup 13, to bring the light hood 31 to swing to various angles, such that after swing, the light hood 31 is fixed to an angle through a force produced by the spring 15 pressing against the spherical body 12, as shown in FIG. 7.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A movable ball-shape connector for a lighting fixture, comprising:
a movable rod, with its lower end connected to a threaded rod extending outward, said threaded rod having a length, and on its surface is provided with outer threads;
a spherical body, with its center provided with a through hole penetrating from its upper end to its lower end, such that said threaded rod is penetrated through said through hole, to put spherical body to an upper end of said threaded rod;
a fix cup, with its center provided with a through hole, such that said threaded rod is penetrated through said through hole, to install the fix cup on said threaded rod and below said spherical body;
a press block, with its center provided with a through hole, such that said threaded rod is penetrated through said through hole, to put the press block on said threaded rod and below said fix cup;
a spring, sleeved around and on the threaded rod, and below said press block, to make an upper end of said spring pressed against said press block; and
an adjusting block, with its center provided with a threaded hole, through threading said threaded hole onto said outer threads of said threaded rod, said adjusting block is installed onto said threaded rod and below said spring, so that lower end of said spring is pressed against said adjusting block, to make said spring to generate an elastic force acting upward, thus producing a force pressing said spherical body to stay between said movable rod and said fix cup, such that after rotation, said spherical body is fixed to an angle, meanwhile, said adjusting block is rotated, to move upward or downward along said outer threads of said threaded rod, to adjust force of said spring pressing against said spherical body.

2. The movable ball-shape connector for a lighting fixture as claimed in claim 1, wherein a spring receiving rod is further provided between said spring and said adjusting block, so that a lower end of said spring is received in said spring receiving rod, to press against said adjusting block indirectly.

3. The movable ball-shape connector for a lighting fixture as claimed in claim 1, wherein said fix cup is installed on a seat body of said light fixture, so that by pushing said movable rod, said spherical body is made to rotate on said fix cup, to bring said movable rod to swing in various angles, such that after swing, said movable rod is fixed to an angle through force produced by said spring pressing against said spherical body.

4. The movable ball-shape connector for a lighting fixture as claimed in claim 1, wherein said fix cup is disposed on a connection block of a light hood of said light fixture, and above said connection block is provided with a lamp seat for installing a light bulb, so that by pushing said connection block, said spherical body is made to rotate on said fix cup, to bring said light hood to swing in various angles, such that after swing, said light hood is fixed to an angle through force produced by said spring pressing against said spherical body.
